(19) United States
(12) Patent Application Publication
(10) Pub. No.: US 2026/0178286 A1
(43) Pub. Date: Jun. 25, 2026

(54) METHOD AND SYSTEM FOR MULTI-AGENTIC AUTOMATED TEST SCRIPT GENERATION

(71) Applicant: LTI Mindtree Ltd, Mumbai (IN)

(72) Inventors: Brijesh Prabhakar, Mumbai (IN); ChandiPrasad Ojha, Mumbai (IN); Meena Malu, Mumbai (IN); Aarya Karambelkar, Mumbai (IN); R Naveen Reddy, Mumbai (IN)

(21) Appl. No.: 19/196,824

(22) Filed: May 2, 2025

(30) Foreign Application Priority Data
Dec. 24, 2024 (IN) 202421102641

(51) Int. Cl. G06F 8/35

(52) U.S. Cl. CPC G06F 8/35

(57) ABSTRACT

A method and system for automatically generating test scripts is disclosed. A domain specialist agent transforms test requirements into structured manual test cases, a test specification agent converts the structured manual test cases into standardized test specifications, a test data agent generates synthetic test data based the test specifications, an object metadata agent processes user interface element locators, a test automation agent generates executable test scripts. A master control agent receives test requirements and object repository, and analyzes the test requirements using predefined rules to identify test generation operations. An artificial intelligence agent is automatically activated based on the test generation operations. A validation control agent verifies output generated by each artificial intelligence agent and determines if the output meets predefined quality criteria, and returns the output to respective agents for refinement when the criteria are not met.

### FIELD

Various embodiments of the present disclosure generally relate to the generation of test scripts. More particularly, the disclosure relates to a method and system for automated test script generation using an integrated multi-agent test automation framework, leveraging a sequence of specialized agents, to process user input data and generate test artifacts.

### BACKGROUND

In modern software development, test automation plays a crucial role in maintaining efficiency, reliability, and scalability of applications. As software systems grow in complexity, the demand for rapid development cycles and high-quality standards has significantly increased. Test automation addresses these challenges by enabling repeatable, consistent, and faster execution of tests compared to manual testing processes. By automating repetitive tasks, organizations can allocate resources to focus on innovative development, reducing the time-to-market while maintaining product reliability.

However, traditional test automation frameworks are not without their limitations. They typically rely on human expertise to design and script automated tests, which introduces several challenges.

Test Automation script creation by skilled resources (e.g., Quality Engineer, Automation Expert) is time-consuming, prone to human error, and often lacks comprehensive coverage. Skilled professionals need to invest significant time in understanding test requirements, translating them into actionable test cases, and scripting them for execution using automation tools. The process is inherently manual and depends heavily on the experience and proficiency of the resources involved. Consequently, inconsistencies in script quality and scope may arise due to differing interpretations of requirements, incomplete understanding of application workflows, or overlooked test scenarios. Furthermore, human-created scripts may fail to account for edge cases or dynamic changes in the application's behavior, leaving critical paths untested. These inefficiencies can lead to gaps in test coverage, reduced software quality, and increased costs associated with debugging and fixing issues post-release.

Existing methods of test automation involve scripting each test case manually, typically using commercially available tools and/or test automation platforms. The tools provide functionalities for automating interactions with web, mobile, or desktop applications, but they come with inherent complexities that pose significant challenges. Creating scripts manually demands a high level of programming expertise, which restricts the pool of qualified professionals capable of contributing effectively. This often necessitates specialized training or dedicated personnel proficient in scripting languages and automation frameworks.

Additionally, manual efforts in traditional automation processes include defining the interactions, identifying UI elements, and structuring validation points for each test case. The approach is labor-intensive, requiring a meticulous setup for each test scenario, including establishing object locators, handling synchronization issues, and coding data-driven or reusable components. Such effort also extends to ongoing script maintenance, as applications evolve with new features, changes in user interfaces, or modifications in underlying services.

Therefore, there is a requirement for a method and system that can address the aforementioned challenges by automatically generating test scripts which overcomes the limitations of manual scripting and enhances test coverage while reducing the burden on testing teams.

### SUMMARY

The present disclosure discloses a method and system for automatically generating test scripts is disclosed. A multi-agent test automation framework of the system comprises a plurality of artificial intelligence agents. The plurality of artificial intelligence agents includes a domain specialist agent that transforms test requirements into structured manual test cases, a test specification agent that converts the structured manual test cases into standardized test specifications, a test data agent that generates synthetic test data based the test specifications, an object metadata agent processes user interface (UI) element locators from an object repository, a test automation agent generates executable test scripts.

A master control agent of the system receives test requirements and analyzes the test requirements using predefined rules to identify test generation operations. One or more artificial intelligence agents of the plurality of artificial agents are automatically activated based on the test generation operations. A validation control agent verifies output generated by each artificial intelligence agent at its respective stage, and determines if the output meets predefined quality criteria, and returns the output to respective agents for refinement when the criteria are not met. Further, upon receiving confirmation from the validation control agent, the master control agent activates subsequent artificial intelligence agents.

One or more advantages of the prior art are overcome, and additional advantages are provided through the disclosure. In addition to illustrative aspects, embodiments, and features described above, further aspects, embodiments, and features will become apparent by reference to drawings and following detailed description.

### BRIEF DESCRIPTION OF THE FIGURES

FIG. 1 is a diagram that illustrates an exemplary environment 100 within which various embodiments of the present disclosure may function.

FIG. 2 is a diagram that illustrates a block diagram of a system 104 for automatically generating test scripts, in accordance with an embodiment of the disclosure.

FIG. 3 is an exemplary diagram that illustrates the system 104 for automatically generating test scripts, in accordance with an embodiment of the disclosure.

FIG. 4 is a diagram that illustrates a flow chart 400 for a method for automatically generating test scripts, in accordance with an embodiment of the disclosure.

### DETAILED DESCRIPTION

Pursuant to various embodiments, the method and system automates generation of test scripts. A multi-agent test automation framework of the system includes a plurality of artificial intelligence agents that includes a domain specialist agent that transforms test requirements into structured manual test cases, a test specification agent that converts the structured manual test cases into standardized test specifications, a test data agent that generates synthetic test data based on the test specifications, an object metadata agent that processes user interface element locators, and a test automation agent that generates executable test scripts.

A master control agent receives test requirements and object repository, and analyzes the test requirements using predefined rules to identify test generation operations. One or more artificial intelligence agents are automatically activated based on the test generation operations. A validation control agent verifies output generated by each artificial intelligence agent at its respective stage, and determines if the output meets predefined quality criteria, and returns the output to respective agents for refinement when the criteria are not met. Further, upon receiving confirmation from the validation control agent, the master control agent activates subsequent artificial intelligence agents.

In one or more embodiments, the test scripts refer to executable programs or sequences of instructions that automate the testing of software applications. The test scripts are designed to perform predefined actions on the application under test (AUT), validate the expected outcomes, and report any deviations. Test scripts may interact with various components of an application, such as user interfaces, APIs, or backend systems, to ensure their functionality, performance, and reliability meet the required specifications.

In one or more embodiments, automation refers to the process of systematically generating, executing, and maintaining test scripts using automated tools, frameworks, or intelligent systems, without significant manual intervention. Automation involves leveraging technologies and methodologies that streamline the creation of scripts, dynamically adapt to application changes, and execute the scripts efficiently across various environments and configurations.

In one or more embodiments, the multi-agent test automation framework refers to a distributed and collaborative system comprising specialized software agents, each designed to perform distinct roles within the test automation lifecycle. The multi-agent automation framework is configured to automate the generation, execution, and validation of test scripts by leveraging the collective intelligence and functionality of its constituent agents. Each agent operates autonomously yet communicates and collaborates with other agents to achieve seamless automation and enhance the efficiency, accuracy, and scalability of the testing process.

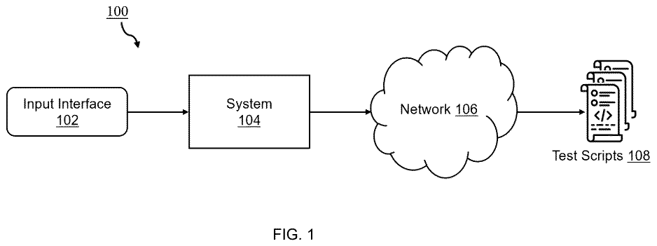

FIG. 1 is a diagram that illustrates an exemplary environment 100 within which various embodiments of the present disclosure may function. Referring to FIG. 1, the environment 100 comprises an input interface 102, a system 104, a network 106, and test scripts 108.

The input interface 102 of the present disclosure is configured to receive test requirements, serving as the primary communication gateway between the user and the system 104. The input interface 102 also receives user interface (UI) element locators from an object repository. The input interface 102 facilitates the seamless intake of descriptions, detailed specifications, and supporting artifacts required for the automated generation of test scripts 108.

In one or more embodiments, the input interface 102 may support various data formats and protocols, enabling compatibility with different tools and workflows. For example, it can receive test requirements via REST APIs, upload templates, or direct integrations with test management systems. Similarly, the object repository can be imported from popular automation frameworks such as, for example, Selenium or Appium, or extracted directly from the application using automated discovery tools.

The system 104 of the present disclosure is configured to leverage artificial intelligence (AI) to automatically generate test scripts 108 by intelligently processing inputs, expected outputs, and defined parameters provided by users or derived from system data. The AI-driven approach allows the system 104 to analyze the test requirements comprehensively, identify key testing scenarios, and create optimized test scripts 108 without the need for manual intervention.

In some non-limiting embodiments, the AI can be a model trained on diverse datasets to automate the creation of test scripts 108 by understanding, processing, and synthesizing inputs such as test requirements, expected outcomes, and defined parameters. The AI can leverage advanced techniques, including natural language processing (NLP), deep learning, and reinforcement learning, to interpret descriptions, analyze structured or semi-structured data, and generate executable scripts tailored to the application's requirements.

The network 106 includes communication networks operable to facilitate communication wirelessly. The network 106 connects a plurality of computer systems and may comprise, for example, an intranet, local area network, wide area network, the internet, or other wireless communication networks.

The test scripts 108 that are generated refers to executable scripts that are automatically created by the multi-agent test automation framework 208 of the system 104 to validate the functionality, performance, and reliability of a software application.

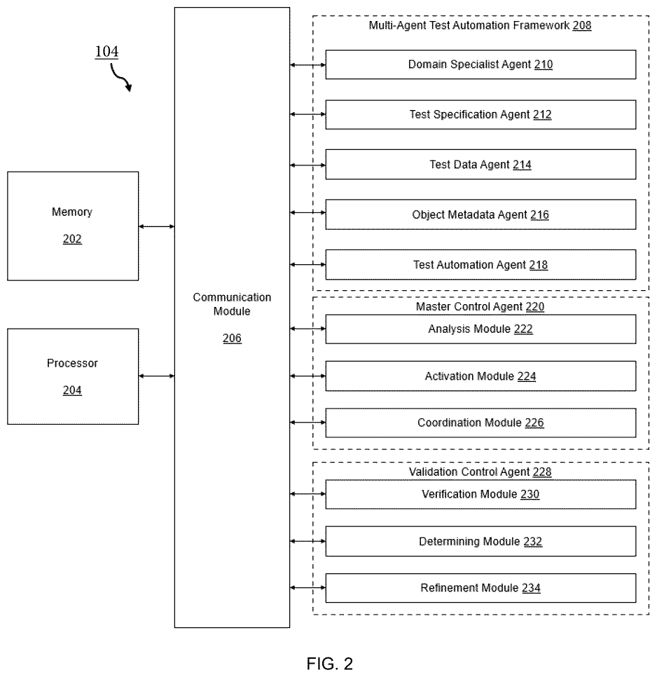

FIG. 2 is a diagram that illustrates a block diagram of the system 104 for automatically generating test scripts, in accordance with an embodiment of the disclosure. Referring to FIG. 2, the system 104 comprises a memory 202, a processor 204, a multi-agent test automation framework 208 includes a plurality of artificial intelligence (AI) agents including a domain specialist agent 210, a test specification agent 212, a test data agent 214, an object metadata agent 216, and a test automation agent 218. The system 104 also comprises a master control agent 220 comprising an analysis module 222, an activation module 224, and a coordination module 226. The system 104 further comprises a validation control agent 228 comprising a verification module 230, determining module 232, and a refinement module 234.

The memory 202 may comprise suitable logic, and/or interfaces, that may be configured to store instructions (for example, computer-readable program code) that can implement various aspects of the present disclosure.

The processor 204 may comprise suitable logic, interfaces, and/or code that may be configured to execute the instructions stored in the memory 202 to implement various functionalities of the system 104 in accordance with various aspects of the present disclosure. The processor 204 may be further configured to communicate with the various modules of the system 104 through the communication module 206, which manages internal and external data communications.

The multi-agent test automation framework 208 may comprise suitable logic, code, and/or interface that may be configured to automate generation, execution, and validation of test scripts by leveraging the collective intelligence and functionality of its constituent agents.

The master control agent 220 of the system 104 may comprise suitable logic, code, and/or interfaces that may be configured to receive test requirements and UI element locators from the object repository via the input interface 102.

In one or more embodiments, the master control agent 220 analyzes the received test requirements using predefined rules to identify required test generation operations using an analysis module 222. The analysis module 222 interprets the test requirements, which may come in the form of natural language descriptions, functional specifications, or other structured inputs. By leveraging predefined rules and algorithms, the analysis module 222 parses these requirements to extract actionable test scenarios, test conditions, and validation criteria.

In some non-limiting embodiments, the analysis module 222 applies NLP techniques or domain-specific pattern recognition methods to break down complex test requirements into simpler, actionable components. For instance, it may identify specific functionalities that need to be tested, such as form submissions, login functionality, or page navigation. Once the test requirements are broken into specific operations, the analysis module 222 may categorize them according to the type of test they correspond to, such as functional, regression, or performance testing.

In one or more embodiments, upon identification, the activation module 224 automatically activates one or more artificial intelligence agents from the plurality of the artificial intelligence agents based on the identified test generation operations. The activation module 224 functions as a trigger mechanism within the master control agent 220, to deploy appropriate AI agents to execute the required tasks in the test script generation process.

In one or more embodiments, when the analysis module 222 identifies a set of test generation operations, the activation module 224 determines which AI agent or agents are best suited to handle each operation based on their capabilities and specialized functions. For example, if the operation involves transforming natural language requirements into structured test cases, the activation module 224 may activate the domain specialist agent 210, which leverages NLP techniques. If the operation pertains to generating synthetic test data, the test data agent 214 might be activated to apply data generation models.

In some non-limiting embodiments, the activation module 224 uses a set of predefined rules or machine learning models to map identified test generation operations to the corresponding AI agents. The AI agents are selected based on factors such as the type of test (functional, regression, performance, etc.), the complexity of the task, and the data required.

The domain specialist agent 210 may comprise suitable logic, code, and/or interface that may be configured to transform test requirements provided by the user, into structured manual test cases using NLP. The test requirements may include functional specifications, user stories, or detailed descriptions of expected behaviors and application workflows. By processing the natural language input, the domain specialist agent 210 extracts key elements such as test scenarios, conditions, expected results, and associated parameters that are essential for test case creation.

In one or more embodiments, once the test requirements are parsed, the domain specialist agent 210 transforms them into structured manual test cases, organizing the information into standardized formats that can be easily understood and processed by other agents in the multi-agent test automation framework 208. The structured manual test cases may include specific steps, inputs, expected outputs, and validation conditions, ensuring that each test scenario is clearly defined and executable.

In one or more embodiments, the domain specialist agent 210 is configured to refer to a domain knowledge base to interpret functional requirements from use case documents. The domain knowledge base serves as a repository of domain-specific information, including terminology, best practices, industry standards, and predefined rules relevant to the application under test. By leveraging the domain knowledge base, the domain specialist agent 210 can more accurately interpret and contextualize the functional requirements described in use case documents.

In one or more embodiments, use case documents contain high-level descriptions of a system's behavior, outlining how users interact with the application and the expected outcomes for various scenarios. For instance, the use case documents often include terms, concepts, and processes that are specific to the business domain, and understanding these nuances is critical for generating relevant and effective test cases.

In one or more embodiments, the domain specialist agent 210 utilizes the domain knowledge base to enrich its understanding of the functional requirements. For instance, when analyzing use case documents, the domain specialist agent 210 may cross-reference terms and concepts with the domain knowledge base to ensure it accurately interprets the meaning and scope of each requirement.

In one or more embodiments, the domain specialist agent 210 generates manual test cases by leveraging the domain knowledge base. The domain specialist agent 210 uses the domain knowledge base to enhance its ability to interpret and transform functional requirements into structured test cases that align with domain-specific practices, terminology, and standards.

The test specification agent 212 may comprise suitable logic, code, and/or interfaces that may be configured to convert the structured manual test cases into standardized test specifications using language model processing. Using language model processing, the test specification agent 212 parses the natural language content of the test cases, identifying key elements such as actions, conditions, expected results, and test parameters. The test specification agent 212 then uses predefined templates, syntax, and rules from the domain knowledge base to transform the elements into a structured, standardized test specification format, which may include specific details like input values, test data ranges, validation criteria, and expected system behaviors.

In an exemplary embodiment, the language model can be a pre-trained deep learning-based NLP model, such as OpenAI's GPT series, BERT (Bidirectional Encoder Representations from Transformers), or other transformer-based models, which are capable of understanding and generating human-like text. The models perform parsing and processing natural language inputs, making them ideal for converting structured manual test cases into standardized test specifications.

The test data agent 214 may comprise suitable logic, code, and/or interfaces that may be configured to generate synthetic test data based on identified parameters from the test specifications.

In one or more embodiments, the test data agent 214 analyzes test specifications using pattern recognition to extract data parameters. The analysis allows the test data agent 214 to identify specific data requirements embedded within the test specifications, which may be described in natural language or structured formats. By leveraging pattern recognition techniques, the test data agent 214 understands the context and intent behind the parameters, enabling it to generate highly relevant and precise synthetic test data.

In an exemplary embodiment, pattern recognition involves the use of algorithms and machine learning models to identify recurring patterns or structures within the test specifications. For instance, the test specifications may describe data requirements such as “numeric values between 1 and 100,” “valid email addresses,” or “dates in the format MM/DD/YYYY.” The test data agent 214 uses pattern recognition to identify these specific data needs, and then extracts the corresponding parameters, such as the data type (e.g., integer, string, date) and any associated constraints (e.g., range, format, or domain).

For instance, if the test specification includes a requirement like “user age should be a value between 18 and 100,” the test data agent 214 recognizes the pattern specifying a numeric value within a given range and extracts the range boundaries (18 and 100). The test data agent 214 can then use this extracted information to generate test data within the specified range, ensuring that the test case accurately reflects the intended scenario.

In one or more embodiments, the test data agent 214 generates synthetic test data by applying data integrity rules, implementing configurable privacy protection algorithms, and enforcing defined security constraints.

In one or more embodiments, the test data agent 214 applies data integrity rules to ensure that the synthetic test data is both valid and consistent. These rules include constraints such as referential integrity (ensuring that relationships between different data entities are maintained), domain integrity (ensuring that the data falls within acceptable values or ranges), and consistency (ensuring that generated data does not conflict with other test data or system states). For example, if the test case requires generating a user profile with a “date of birth” field, the test data agent 214 will ensure that the generated date of birth is logically valid (e.g., it cannot be a future date), and consistent with other generated user information (e.g., the age calculated from the date of birth matches the expected range).

In one or more embodiments, to address privacy concerns, the test data agent 214 can implement configurable privacy protection algorithms, to ensure that the generated synthetic test data does not inadvertently expose sensitive or personally identifiable information (PII). For instance, if the test data involves user information such as names, email addresses, or phone numbers, the test data agent 214 can use anonymization techniques to generate non-identifiable data that still retains realistic characteristics for testing purposes.

In one or more embodiments, the test data agent 214 enforces defined security constraints to safeguard against the generation of data that could be exploited maliciously or expose vulnerabilities in a system that is being tested. The constraints can include rules for encrypting sensitive fields, controlling access to privileged data, and ensuring that data types used in the test cases adhere to expected formats that prevent injection attacks or other security breaches.

For example, if a test case requires the generation of login credentials for testing an authentication system, the test data agent 214 may enforce security constraints by ensuring that the generated passwords adhere to predefined complexity rules (e.g., a combination of upper/lowercase letters, numbers, and special characters). Similarly, for tests involving payment information, the test data agent 214 can ensure that the generated credit card numbers are structured correctly but do not correspond to real financial data.

In some non-limiting embodiments, the synthetic test data generated by the test data agent 214 can span a wide range of scenarios, including common cases, edge cases, and potential failure modes. For instance, the test data agent 214 may generate data that tests a system's behavior under extreme conditions, such as maximum input values, or invalid inputs, like empty fields or special characters.

The object metadata agent 216 may comprise suitable logic, code, and/or interfaces that may be configured to process UI element locators from the object repository to map element identification data. The functionality connects the abstract definitions of UI elements in the object repository and their practical application in test scripts.

In one or more embodiments, the object repository contains a structured collection of UI element, each associated with attributes or locators such as ID, name, XPath, CSS selectors, or other identifiers used for element recognition. The object metadata agent 216 retrieves the data and processes it to create a detailed mapping of element identification data.

In an exemplary embodiment, if the object repository includes a “login” button identified by an XPath such as //button[@id=‘login’], the object metadata agent 216 extracts this locator and translates it into a format compatible with the multi-agent automation framework 208 that is utilized. The object metadata agent 216 may also standardize locator formats or address conflicts between multiple locators linked to the same UI element, reducing errors during test execution and simplifying script maintenance.

In one or more embodiments, the object metadata agent 216 is configured to refer to UI specifications using machine learning models to generate element identification pattern based on historical interaction data. By analyzing historical interaction logs, the object metadata agent 216 identifies recurring patterns and trends in how UI elements are accessed and interacted with, during testing scenarios.

In one or more embodiments, the use of machine learning models allows the object metadata agent 216 to interpret UI specifications, which may include details such as layout structures, element hierarchies, and associated behaviors. For instance, if the historical data reveals that a “submit” button is frequently identified using a combination of XPath and unique class attributes, the object metadata agent 216 can prioritize such patterns when generating identification rules for similar elements.

In one or more embodiments, the object metadata agent 216 refines the generated patterns by incorporating feedback from previously executed test cases. If an identification pattern leads to a high success rate in locating the intended UI elements, the pattern is reinforced within the object metadata agent's 216 model. Conversely, patterns that result in failures or inconsistencies are flagged for optimization.

In one or more embodiments, the object metadata agent 216 maintains a structured mapping between test steps and user interface elements in order to streamline the interaction between automated test scripts and the application under test. The mapping is built by linking each test step, such as “click,” “input text,” or “select from dropdown,” to the relevant UI element, such as a button, textbox, or dropdown menu. Each UI element is identified using its attributes, including locators like ID, XPath, CSS selectors, or other unique identifiers. The structured mapping also incorporates metadata about the UI elements, such as their hierarchy within the page layout, dynamic properties, and functional context.

In an exemplary embodiment, consider a test scenario where a user logs into an application, the structured mapping may associate the test step “Enter username” with a textbox identified by its ID or placeholder attribute, and the test step “Click login” with a button identified by its class or text content. The explicit linkage ensures that the automated test script performs the intended actions on the correct UI components during execution.

In some non-limiting embodiments, the object metadata agent 216 dynamically updates the mapping to reflect changes in the UI. If a locator or attribute of a UI element is modified due to an application update, the object metadata agent 216 identifies the changes and revises the mapping accordingly.

The test automation agent 218 may comprise suitable logic, code, and/or interface that may be configured to generate executable test scripts by applying code generation models along with the synthetic test data to test specifications and element identification data.

In one or more embodiments, to generate test scripts, the test automation agent 218 initially processes the structured test specifications, which outlines the sequence of test steps and expected outcomes. It also integrates the synthetic test data produced by the test data agent 214, ensuring the test scripts are equipped with appropriate input values for diverse testing scenarios. Additionally, the test automation agent 218 utilizes element identification data generated by the object metadata agent 216 to map each test step to the corresponding user interface elements accurately.

In one or more embodiments, by applying code generation models, the test automation agent 218 transforms the inputs into executable scripts written in programming or scripting languages supported by the chosen test automation platform, such as for example, Python, Java, or JavaScript. The code generation models are designed to interpret the logical flow of test specifications and convert them into syntactically correct and semantically meaningful code. For instance, a test specification step to “click the login button” would translate into a code snippet invoking the appropriate method to locate and interact with the login button within the UI.

In one or more embodiments, the test automation agent 218 is configured to analyze test specifications to identify automation patterns and generate automated code using code generation models. The analysis of test specifications involves parsing the structured test cases to extract actionable details, such as test steps, expected outcomes, and relationships with UI elements. The test automation agent 218 identifies patterns within these specifications, such as repeated actions (e.g., data entry, button clicks, or navigation sequences), conditional logic, or iterations.

In an exemplary embodiment, if the test specifications include a recurring sequence of steps to log into an application, the test automation agent 218 identifies this as a reusable pattern. It then generates a standalone function or method for the login process, which can be invoked across multiple test scripts.

In some non-limiting embodiments, the test automation agent 218 may employ advanced code generation models, which may include transformer-based language models or rule-based systems, to translate the identified patterns and test specifications into executable code. The code generation models leverage their understanding of programming syntax and semantics to generate accurate and efficient test scripts in the desired programming language. For instance, the test automation agent 218 might produce a Python script with Selenium methods for interacting with web elements or a JavaScript test case for a custom automation framework.

In one or more embodiments, the test automation agent 218 may integrate contextual information from element identification data and synthetic test data into the generated code to enable each test step is correctly linked to the corresponding UI element and is executed with the appropriate input values.

In one or more embodiments, the test automation agent 218 maps the synthetic test data to the generated automated code, and subsequently maps the UI element identification data to the generated automated code. The first mapping step involves associating synthetic test data with specific variables, input fields, or test conditions defined in the generated code. Synthetic test data, produced by the test data agent 214, represents a wide range of input scenarios, including edge cases, invalid inputs, and typical user behavior. The test automation agent 218 inserts this data into appropriate sections of the test scripts, enabling that the tests dynamically adapt to varied input conditions. For example, if a test specification includes a field for user login credentials, the test automation agent 218 maps corresponding synthetic data, such as usernames and passwords, to that field within the script.

In one or more embodiments, after embedding the test data, the test automation agent 218 performs a second mapping operation to incorporate UI element identification data into the code. The data, generated by the object metadata agent 216, provides the locators or identifiers necessary to interact with UI elements, such as buttons, text fields, or drop-down menus. The test automation agent 218 maps the identifiers to the respective test steps in the generated code, ensuring precise interaction with the application under test. For instance, the locator for a “Submit” button is mapped to the test script segment responsible for simulating a click event.

In one or more embodiments, the test automation agent 218 thereby generates executable test scripts by integrating multiple data streams, including test specifications, synthetic test data, and UI element identification data. The test automation agent 218 may initially analyze the test specifications to determine the sequence of operations, expected outcomes, and conditions required for execution. It uses advanced code generation models to translate these specifications into programming constructs, producing scripts in a format compatible with the chosen automation framework or tool. Thereafter, the test automation agent 218 incorporates synthetic test data into the scripts, embedding dynamic values that simulate real-world usage scenarios.

In one or more embodiments, the test automation agent 218 may simultaneously map UI element identification data to the relevant code segments within the scripts, which establishes precise control over UI interactions, enabling the scripts to locate and interact with elements such as buttons, text fields, and dropdown menus accurately.

In one or more embodiments, the master control agent 220, by utilizing the coordination module 226, manages sequential generation of test artifacts. The coordination module 226 acts as an orchestration layer to enable the test artifacts are generated in a logical, ordered sequence to maintain coherence and alignment with the test requirements.

In one or more embodiments, the coordination module 226 executes various test generation operations in a step-by-step manner, with each step dependent on the output from the previous one. For example, it may start by triggering the domain specialist agent 210 to generate structured manual test cases, then proceed to activate the test specification agent 212 to convert these manual cases into standardized test specifications, followed by the test data agent 214 to generate the necessary synthetic data, and so on.

In some non-limiting embodiments, the coordination module 226 handles synchronization of multiple agents working in parallel, ensuring that no agent is left behind and that the overall process proceeds without delays or errors. If a task requires outputs from multiple agents, the coordination module 226 manages the flow of data between them, to make sure that the results are passed along the correct pipeline.

In one or more embodiments, the master control agent 220 is configured to store test artifacts in a predefined format, and maintains contextual relationships between the stored artifacts. The predefined format allows for easy retrieval and reference, streamlining the process of test execution and validation. The structure ensures that each artifact, whether it is a test case, test data, or a generated script, is categorized and stored according to its role in the testing lifecycle. For example, test cases and specifications might be grouped by functionality or test type, while test scripts and data are organized based on their execution requirements.

In one or more embodiments, the master control agent 220 maintains contextual relationships between the stored artifacts. For instance, a test specification generated by the test specification agent 212 can be directly associated with the synthetic test data generated by the test data agent 214 and the corresponding test automation script created by the test automation agent 218.

In one or more embodiments, the master control agent 220 is further configured to provide controlled access to the plurality of artificial intelligence agents through defined interfaces, which serve as the communication channels between the master control agent 220 and the artificial intelligence agents in the system 104, allowing for secure and regulated interaction.

In one or more embodiments, the defined interfaces may control the flow of information to and from the artificial intelligence agents, ensuring that only relevant data is exchanged, and that the agents are activated or deactivated as needed based on specific requirements.

The validation control agent 228 of the system 104 may comprise suitable logic, code, and/or interfaces that may be configured to verify, using the verification module 230, output generated by each artificial intelligence agent at its respective stage.

In one or more embodiments the validation control agent 228, by utilizing the determining module 232, determines if the output meets predefined quality criteria. The determining module 232 evaluates the output generated by each artificial intelligence agent to assess whether it adheres to the specified standards for accuracy, completeness, and relevance.

In one or more embodiments, the predefined quality criteria may include factors such as the consistency of the output with the initial test requirements, the proper format of the generated artifacts, the alignment of the test data with the test specifications, and the correctness of the generated test scripts in terms of their expected behavior. For instance, when the test automation agent 218 generates executable test scripts, the determining module 232 ensures that the generated code is free of syntax errors, includes the correct test steps, and properly integrates the synthetic test data and UI element locators.

In one or more embodiments, the validation control agent 228, by utilizing the refinement module 234, returns the output to the respective agent for refinement when criteria are not met. The refinement module 234 is responsible for managing the iterative process of output improvement, ensuring that the generated artifacts meet the required standards before they can move forward in the test automation pipeline.

In one or more embodiments, when the determining module 232 identifies that the output does not meet the predefined quality criteria, the refinement module 234 triggers a feedback loop. It returns the output to the respective artificial intelligence agent, which then revisits its output generation process. For example, if the synthetic test data generated by the test data agent 214 is found to be incomplete or inconsistent with the test specifications, the refinement module 234 will direct the test data agent to adjust the data generation process and revalidate the test data.

In one or more embodiments, based on the confirmation from the validation control agent 228, the master control agent 220 activates subsequent artificial intelligence agents. Once the validation control agent 228 confirms that the output from a given artificial intelligence agent meets the predefined quality criteria, the master control agent 220 is responsible for triggering the next phase of the test automation pipeline.

In one or more embodiments, the activation of subsequent artificial intelligence agents ensures a seamless progression through the test generation workflow. For instance, once the domain specialist agent 210 has successfully generated structured manual test cases and the output has been validated, the master control agent 220 can activate the test specification agent 212 to convert these cases into standardized test specifications. Similarly, once the test specifications have been validated, the master control agent 220 activates the next agent in the sequence, such as the test data agent 214, to generate the required synthetic test data.

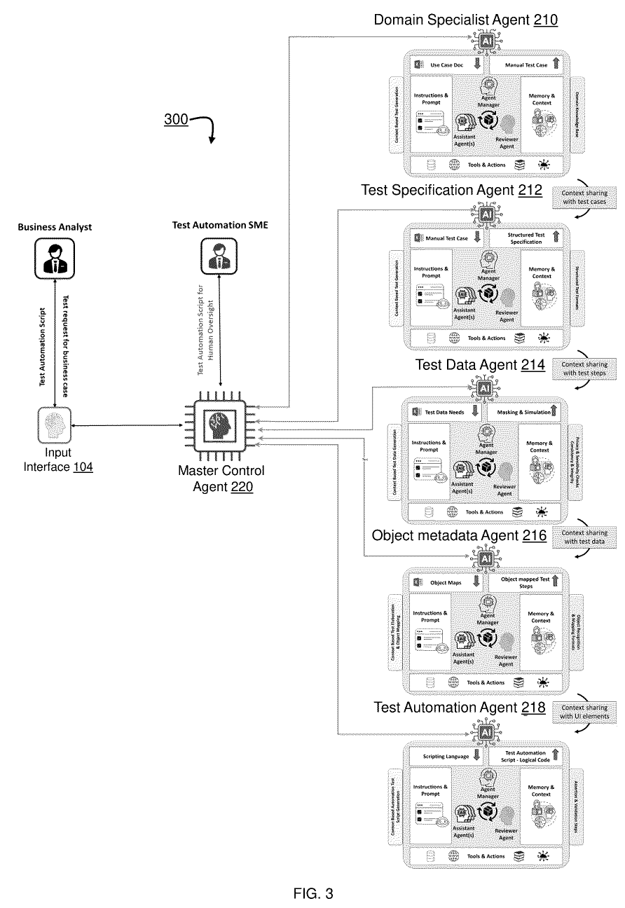

FIG. 3 is an exemplary diagram 300 that illustrates the system 104 automatically generating test scripts, in accordance with an embodiment of the disclosure.

As illustrated in FIG. 3, the system 104 leverages a sequence of specialized agents, including the multi-agent test automation framework 208, master control agent 220, and validation control agent 228, to process user input data and generate comprehensive test artifacts.

Referring to FIG. 3, an exemplary embodiment illustrates a use case where a business analyst seeks to accelerate the test automation process by providing requirement documents via the input interface 102. The objective is to generate test automation scripts for product-specific test scenarios. The system 104 employs the multi-agent test automation framework 208, with each agent performing specialized tasks in the script generation process.

The master control agent 220 receives test requirements and an object repository, analyzing the requirements using predefined rules to identify the test generation operations.

For example, when provided with a use case to verify a banking application's fund transfer functionality, the master control agent 220 identifies operations such as validating account details, checking sufficient balance, and executing a transfer request.

The domain specialist agent 210 interprets functional requirements from use case documents and translates them into manual test cases with precision and completeness.
For the fund transfer functionality, the domain specialist agent 210 creates test cases that include steps such as verifying the source account, entering the destination account details, specifying the transfer amount, and confirming the transaction. Leveraging domain-specific knowledge, the agent ensures all critical paths, such as handling invalid account numbers or insufficient funds, are covered in the manual test cases.

The test specification agent 212 transforms the manual test cases into actionable structured test specifications.
For example, the test specification agent 212 generates specifications detailing the exact input fields, expected outputs, and error messages for scenarios like entering a valid amount, exceeding the transfer limit, and processing a transaction successfully.

The test data agent 214 automates the creation and preparation of synthetic test data relevant to the banking domain.
For instance, it generates test data including anonymized account numbers, randomized transaction amounts within set limits, and synthetic user profiles for testing scenarios like joint accounts or business accounts. Additionally, it ensures that sensitive information, such as account holder names, is masked to comply with data security standards.

The object metadata agent 216 identifies and classifies user interface (UI) elements within the banking application.
For example, it recognizes UI components such as input fields for account numbers, dropdown menus for selecting transaction types, and buttons for initiating or canceling a transfer. It associates these elements with unique locators, ensuring compatibility with various test automation tools and facilitating seamless script generation even if minor UI changes occur.

The test automation agent 218 generates executable test scripts by integrating annotations and validation checks.
For example, the test automation agent 218 generates scripts to validate that the entered account numbers conform to a specific format, the transfer amount does not exceed the account balance, and error messages are displayed for invalid inputs. The scripts also verify that a success message and transaction reference number are generated after a successful transfer. Leveraging historical data, the test automation agent 218 optimizes these scripts by including edge cases, such as handling simultaneous fund transfer requests from multiple users.

In some non-limiting embodiments, the system 104 is configured to dynamically instantiate multiple AI agents based on specific requirements. For example, the system 104 may deploy a “Duck Creek Test Agent” tailored to handle test scenarios related to the Duck Creek product, while simultaneously deploying another agent, such as a “Web Application Test Agent,” designed to address test scenarios specific to a particular web application. This modular and adaptive framework enables the system 104 to cater to diverse testing needs across various products and applications.

The multiple AI agents within the multi-agent test automation framework 208 function as a cohesive team, each seamlessly interacting with its specific ecosystem. Operating autonomously, every agent perceives its environment, evaluates its conditions, makes informed decisions, and executes appropriate actions to achieve its designated tasks.

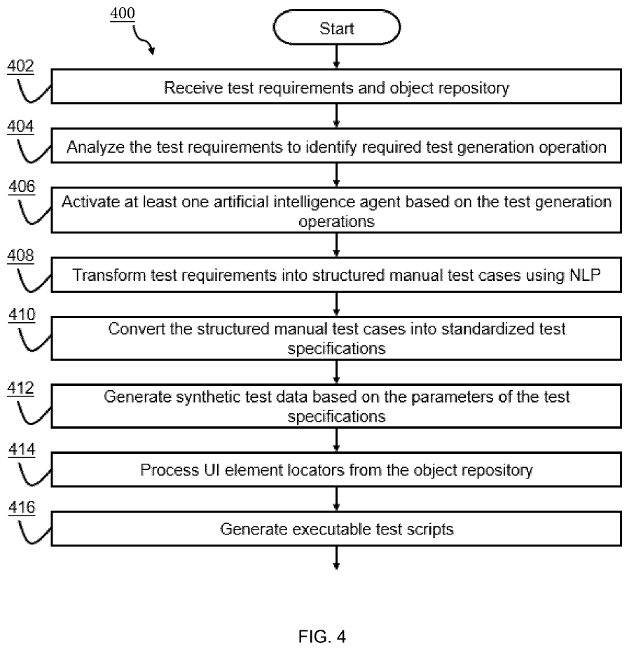

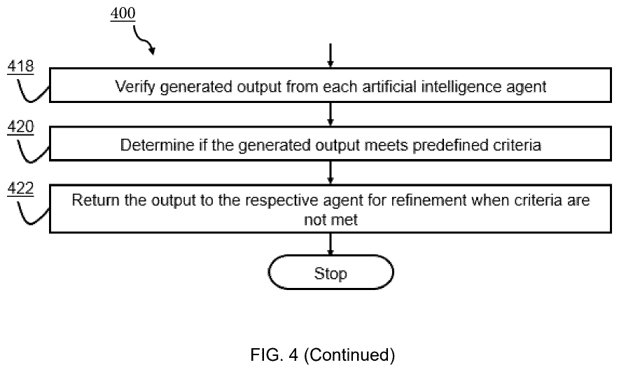

FIG. 4 is a diagram that illustrates a flow chart 400 for a method for automatically generating test scripts, in accordance with an embodiment of the disclosure.

At 402, the master control agent 220 receives test requirements and object repository via the input interface 102.

In one or more embodiments, the input interface 102 may support various data formats and protocols, enabling compatibility with different tools and workflows. For example, it can receive test requirements via REST APIs, upload templates, or direct integrations with test management systems. Similarly, the object repository can be imported from popular automation frameworks such as, for example, Selenium or Appium, or extracted directly from the application using automated discovery tools.

At 404, the test requirements are analyzed by the analysis module 222 to identify the required test generation operation. The analysis module 222 interprets the test requirements, which may come in the form of natural language descriptions, functional specifications, or other structured inputs. By leveraging predefined rules and algorithms, the analysis module 222 parses these requirements to extract actionable test scenarios, test conditions, and validation criteria.

In some non-limiting embodiments, the analysis module 222 applies NLP techniques or domain-specific pattern recognition methods to break down complex test requirements into simpler, actionable components. For instance, it may identify specific functionalities that need to be tested, such as form submissions, login functionality, or page navigation. Once the test requirements are broken down into specific operations, the analysis module 222 may categorize them according to the type of test they correspond to, such as functional, regression, or performance testing.

At 406, the activation module 224 activates one or more artificial intelligence agents from the plurality of the artificial intelligence agents based on the test generation operations. The activation module 224 functions as a trigger mechanism within the master control agent 220, to deploy appropriate AI agents to execute the required tasks in the test script generation process.

In one or more embodiments, when the analysis module 222 identifies a set of test generation operations, the activation module 224 determines which AI agent or agents are best suited to handle each operation based on their capabilities and specialized functions. For example, if the operation involves transforming natural language requirements into structured test cases, the activation module 224 may activate the domain specialist agent 210, which leverages NLP techniques. If the operation pertains to generating synthetic test data, the test data agent 214 might be activated to apply data generation models.

In some non-limiting embodiments, the activation module 224 uses a set of predefined rules or machine learning models to map identified test generation operations to the corresponding AI agents. The AI agents are selected based on factors such as the type of test (functional, regression, performance, etc.), the complexity of the task, and the data required.

At 408, the domain specialist agent 210 transforms test requirements into structured manual test cases using NLP. The test requirements may include functional specifications, user stories, or detailed descriptions of expected behaviors and application workflows. By processing the natural language input, the domain specialist agent 210 extracts key elements such as test scenarios, conditions, expected results, and associated parameters that are essential for test case creation.

In one or more embodiments, once the test requirements are parsed, the domain specialist agent 210 transforms them into structured manual test cases, organizing the information into standardized formats that can be easily understood and processed by other agents in the multi-agent test automation framework 208. The structured manual test cases may include specific steps, inputs, expected outputs, and validation conditions, ensuring that each test scenario is clearly defined and executable.

In one or more embodiments, the domain specialist agent 210 is configured to refer to a domain knowledge base to interpret functional requirements from use case documents. The domain knowledge base serves as a repository of domain-specific information, including terminology, best practices, industry standards, and predefined rules relevant to the application under test. By leveraging the domain knowledge base, the domain specialist agent 210 can more accurately interpret and contextualize the functional requirements described in use case documents.

In one or more embodiments, use case documents contain high-level descriptions of a system's behavior, outlining how users interact with the application and the expected outcomes for various scenarios. For instance, the use case documents often include terms, concepts, and processes that are specific to the business domain, and understanding these nuances is critical for generating relevant and effective test cases.

At 410, the structured manual test cases are converted into standardized test specifications by the test specification agent 212. Using language model processing, the test specification agent 212 parses the natural language content of the test cases, identifying key elements such as actions, conditions, expected results, and test parameters. The test specification agent 212 then uses predefined templates, syntax, and rules from the domain knowledge base to transform the elements into a structured, standardized test specification format, which may include specific details like input values, test data ranges, validation criteria, and expected system behaviors.

At 412, the test data agent 214 generates synthetic test data based on the identified parameters of the test specifications.

In one or more embodiments, the test data agent 214 analyzes test specifications using pattern recognition to extract data parameters. The analysis allows the test data agent 214 to identify specific data requirements embedded within the test specifications, which may be described in natural language or structured formats. By leveraging pattern recognition techniques, the test data agent 214 understands the context and intent behind the parameters, enabling it to generate highly relevant and precise synthetic test data.

In one or more embodiments, the test data agent 214 generates synthetic test data by applying data integrity rules, implementing configurable privacy protection algorithms, and enforcing defined security constraints.

In one or more embodiments, the test data agent 214 applies data integrity rules to ensure that the synthetic test data is both valid and consistent. These rules include constraints such as referential integrity (ensuring that relationships between different data entities are maintained), domain integrity (ensuring that the data falls within acceptable values or ranges), and consistency (ensuring that generated data does not conflict with other test data or system states). For example, if the test case requires generating a user profile with a “date of birth” field, the test data agent 214 will ensure that the generated date of birth is logically valid (e.g., it cannot be a future date), and consistent with other generated user information (e.g., the age calculated from the date of birth matches the expected range).

At 414, UI element locators from the object repository are processed by the object metadata agent 216 to map element identification data. The functionality connects the abstract definitions of UI elements in the object repository and their practical application in test scripts.

In one or more embodiments, the object repository contains a structured collection of UI element, each associated with attributes or locators such as ID, name, XPath, CSS selectors, or other identifiers used for element recognition. The object metadata agent 216 retrieves the data and processes it to create a detailed mapping of element identification data.

In one or more embodiments, the object metadata agent 216 is configured to refer to UI specifications using machine learning models to generate element identification pattern based on historical interaction data. By analyzing historical interaction logs, the object metadata agent 216 identifies recurring patterns and trends in how UI elements are accessed and interacted with, during testing scenarios.

In one or more embodiments, the use of machine learning models allows the object metadata agent 216 to interpret UI specifications, which may include details such as layout structures, element hierarchies, and associated behaviors. For instance, if the historical data reveals that a “submit” button is frequently identified using a combination of XPath and unique class attributes, the object metadata agent 216 can prioritize such patterns when generating identification rules for similar elements.

In one or more embodiments, the object metadata agent 216 refines the generated patterns by incorporating feedback from previously executed test cases. If an identification pattern leads to a high success rate in locating the intended UI elements, the pattern is reinforced within the object metadata agent's 216 model. Conversely, patterns that result in failures or inconsistencies are flagged for optimization.

In one or more embodiments, the object metadata agent 216 maintains a structured mapping between test steps and user interface elements in order to streamline the interaction between automated test scripts and the application under test. The mapping is built by linking each test step, such as “click,” “input text,” or “select from dropdown,” to the relevant UI element, such as a button, textbox, or dropdown menu. Each UI element is identified using its attributes, including locators like ID, XPath, CSS selectors, or other unique identifiers. The structured mapping also incorporates metadata about the UI elements, such as their hierarchy within the page layout, dynamic properties, and functional context.

At 416, the test automation agent 218 generates executable test scripts by applying code generation models along with the synthetic test data to test specifications and element identification data.

At 418, the validation control agent 228 verifies generated output from each artificial intelligence agent using the verification module 230. In one or more embodiments, to generate test scripts, the test automation agent 218 initially processes the structured test specifications, which outlines the sequence of test steps and expected outcomes. It also integrates the synthetic test data produced by the test data agent 214, ensuring the test scripts are equipped with appropriate input values for diverse testing scenarios. Additionally, the test automation agent 218 utilizes element identification data generated by the object metadata agent 216 to map each test step to the corresponding user interface elements accurately.

In one or more embodiments, by applying code generation models, the test automation agent 218 transforms the inputs into executable scripts written in programming or scripting languages supported by the chosen test automation platform, such as for example, Python, Java, or JavaScript. The code generation models are designed to interpret the logical flow of test specifications and convert them into syntactically correct and semantically meaningful code. For instance, a test specification step to “click the login button” would translate into a code snippet invoking the appropriate method to locate and interact with the login button within the UI.

In one or more embodiments, the test automation agent 218 is configured to analyze test specifications to identify automation patterns and generate automated code using ode generation models. The analysis of test specifications involves parsing the structured test cases to extract actionable details, such as test steps, expected outcomes, and relationships with UI elements. The test automation agent 218 identifies patterns within these specifications, such as repeated actions (e.g., data entry, button clicks, or navigation sequences), conditional logic, or iterations.

In one or more embodiments, the test automation agent 218 maps the synthetic test data to the generated automated code, and subsequently maps the UI element identification data to the generated automated code. The first mapping step involves associating synthetic test data with specific variables, input fields, or test conditions defined in the generated code. Synthetic test data, produced by the test data agent 214, represents a wide range of input scenarios, including edge cases, invalid inputs, and typical user behavior. The test automation agent 218 inserts this data into appropriate sections of the test scripts, enabling that the tests dynamically adapt to varied input conditions. For example, if a test specification includes a field for user login credentials, the test automation agent 218 maps corresponding synthetic data, such as usernames and passwords, to that field within the script.

In one or more embodiments, after embedding the test data, the test automation agent 218 performs a second mapping operation to incorporate UI element identification data into the code. The data, generated by the object metadata agent 216, provides the locators or identifiers necessary to interact with UI elements, such as buttons, text fields, or drop-down menus. The test automation agent 218 maps the identifiers to the respective test steps in the generated code, ensuring precise interaction with the application under test. For instance, the locator for a “Submit” button is mapped to the test script segment responsible for simulating a click event.

In one or more embodiments, the test automation agent 218 thereby generates executable test scripts by integrating multiple data streams, including test specifications, synthetic test data, and UI element identification data. The test automation agent 218 may initially analyze the test specifications to determine the sequence of operations, expected outcomes, and conditions required for execution. It uses advanced code generation models to translate these specifications into programming constructs, producing scripts in a format compatible with the chosen automation framework or tool. Thereafter, the test automation agent 218 incorporates synthetic test data into the scripts, embedding dynamic values that simulate real-world usage scenarios.

At 420, the determining module 232 determines if the generated output meets predefined criteria. The determining module 232 evaluates the output generated by each artificial intelligence agent to assess whether it adheres to the specified standards for accuracy, completeness, and relevance.

In one or more embodiments, the predefined quality criteria may include factors such as the consistency of the output with the initial test requirements, the proper format of the generated artifacts, the alignment of the test data with the test specifications, and the correctness of the generated test scripts in terms of their expected behavior. For instance, when the test automation agent 218 generates executable test scripts, the determining module 232 ensures that the generated code is free of syntax errors, includes the correct test steps, and properly integrates the synthetic test data and UI element locators.

At 422, the refinement module 234 returns the output to the respective agent for refinement when the criteria are not met. The refinement module 234 is responsible for managing the iterative process of output improvement, ensuring that the generated artifacts meet the required standards before they can move forward in the test automation pipeline.

In one or more embodiments, when the determining module 232 identifies that the output does not meet the predefined quality criteria, the refinement module 234 triggers a feedback loop. It returns the output to the respective artificial intelligence agent, which then revisits its output generation process. For example, if the synthetic test data generated by the test data agent 214 is found to be incomplete or inconsistent with the test specifications, the refinement module 234 will direct the test data agent to adjust the data generation process and revalidate the test data.

The method and system is advantageous in that it provides multi-agentic framework for test automation, where specialized artificial intelligence agents collaborate to transform manual test requirements into executable test scripts. This distributed intelligence architecture significantly enhances processing capabilities, enables parallel execution, and provides enhanced scalability compared to conventional testing approaches, while reducing resource utilization and eliminating manual intervention.

Further, the method and system is advantageous in that it implements an intelligent orchestration mechanism through a master control agent that dynamically analyzes test requirements, activates appropriate specialized agents, and manages complex testing workflows. This automated orchestration enables optimal resource allocation, efficient information routing between agents, and systematic progression of test artifact generation, thereby significantly reducing processing bottlenecks and improving overall system efficiency.

Furthermore, the method and system is advantageous in that it incorporates a self-validating architecture through a dedicated validation control agent that automatically verifies outputs at each processing stage. This continuous validation mechanism ensures quality threshold maintenance, enables automated refinement loops, and prevents error propagation, thereby maintaining high accuracy throughout the test generation process.

Additionally, the method and system is advantageous in that it enables comprehensive test coverage through specialized processing agents that handle distinct aspects of test generation, from domain analysis to test script creation. The system's ability to automatically identify test parameters, generate synthetic data, and systematically map UI elements ensures thorough validation of application functionality while maintaining testing precision.

Moreover, the method and system is advantageous in that it optimizes resource utilization through automated allocation of processing capabilities based on testing requirements. This intelligent resource management, coupled with the elimination of manual handoffs between testing phases, significantly reduces operational overhead while maintaining testing efficiency and quality.

Furthermore, the method and system integrates responsible AI principles to promote fairness and prevent bias in script generation. By incorporating technical controls, the system enhances transparency and enables auditability throughout the automated testing process.

Furthermore, the method and system implements robust data privacy measures to safeguard sensitive test data during the conversion and automation processes. The system's architecture incorporates automated privacy controls and standardized security measures, ensuring compliance with regulatory requirements.

Those skilled in the art will realize that the above-recognized advantages and other advantages described herein are merely exemplary and are not meant to be a complete rendering of all of the advantages of the various embodiments of the present disclosure.

In the foregoing complete specification, specific embodiments of the present disclosure have been described. However, one of ordinary skill in the art appreciates that various modifications and changes can be made without departing from the scope of the present disclosure. Accordingly, the specification and figures are to be regarded in an illustrative rather than a restrictive sense. All such modifications are intended to be included within the scope of the present disclosure.

What is claimed is:

1. A system for automated test script generation, comprising:
a processor;
a memory storing instructions that, when executed by the processor, cause the system to implement:
a multi-agent test automation framework comprising:
a plurality of artificial intelligence agents comprising:
a domain specialist agent programmed to transform test requirements into structured manual test cases using natural language processing;
a test specification agent programmed to convert the structured manual test cases into standardized test specifications using language model processing;
a test data agent programmed to generate synthetic test data based on identified parameters from the test specifications;
an object metadata agent programmed to process user interface element locators from an object repository to map element identification data;
a test automation agent programmed to generate executable test scripts by applying code generation models along with the synthetic test data to the test specifications and element identification data;
a master control agent programmed to:
receive, via an input interface, test requirements and the object repository;
analyze the test requirements using predefined rules to identify required test generation operations;
automatically activate at least one artificial intelligence agent from the plurality of the artificial intelligence agents based on the test generation operations;
coordinate information exchange between activated artificial intelligence agents;
manage sequential generation of test artifacts;
a validation control agent programmed to:
verify output generated by each artificial intelligence agent at its respective stage;
determine if the output meets predefined quality criteria; and
return the output to the respective agent for refinement when criteria are not met, wherein the master control agent activates subsequent artificial intelligence agents based on the validation control agent confirmation.

2. The system of claim 1, wherein the master control agent implements a structured data repository programmed to:
store test artifacts in a predefined format;
maintain contextual relationships between stored artifacts;
provide controlled access to artificial intelligence agents through defined interfaces.

3. The system of claim 1, wherein the domain specialist agent is configured to:
refers to a domain knowledge base;
interprets functional requirements from use case documents; and
generates manual test cases by leveraging the domain knowledge base.

4. The system of claim 1, wherein the test data agent is programmed to:
analyze test specifications using pattern recognition to extract data parameters; and
generate synthetic test data by applying data integrity rules, implementing configurable privacy protection algorithms, and enforcing defined security constraints.

5. The system of claim 1, wherein the object metadata agent is programmed to:
refer to user interface specifications using machine learning models;
generate element identification patterns based on historical interaction data; and
maintain a structured mapping between test steps and user interface elements.

6. The system of claim 1, wherein the test automation agent is programmed to:
analyze test specifications to identify automation patterns;
generate automated code using code generation models;
map the synthetic test data to the generated automated code;
map the user interface element identification data to the generated automated code; and
generate executable test scripts.

7. A computer-implemented method for automated test script generation, comprising:
receiving, by a master control agent, test requirements and an object repository;
analyzing, by the master control agent, the test requirements to identify required generation operations;
activating, by the master control agent, specific artificial intelligence agents from the plurality of artificial intelligence agents, wherein the plurality of artificial intelligence agents comprise:
a domain specialist agent that transforms test requirements into structured manual test cases using natural language processing;
a test specification agent that converts the structured manual test cases into standardized test specifications using language model processing;
a test data agent that generates synthetic test data based on parameters defined in the test specifications;
an object metadata agent that identifies user interface element locators from the object repository to generate element identification data;
a test automation agent that generates executable test scripts by applying code generation models;
coordinating, by the master control agent, information exchange between activated artificial intelligence agents;
verifying, by a validation control agent, generated output from each artificial intelligence agent;
determining if the generated output meets predefined criteria; and
returning the output to the respective agent for refinement when criteria are not met; and
activating, by the master control agent, subsequent artificial intelligence agents based on validation control agent confirmation.

8. The method of claim 7, comprising:
referring to a domain knowledge base;
interpreting functional requirements from use case documents; and
generating manual test cases by leveraging the domain knowledge base.

9. The method of claim 7, comprising:
analyzing test specifications using pattern recognition to extract data parameters;
generating synthetic test data by applying data integrity rules, and implementing configurable privacy protection algorithms, and enforcing defined security constraints.

10. The method of claim 7, comprising:
referring to user interface specifications using machine learning models;
generating element identification patterns based on historical interaction data; and
maintaining a structured mapping between test steps and user interface elements.

11. The method of claim 7, comprising:
analyzing test specifications to identify automation patterns;
generating automated code using code generation models;
mapping the synthetic test data to the generated automated code;
mapping the user interface element identification data to the generated automated code; and
generate executable test scripts.
